(19) United States
(12) Patent Application Publication
(10) Pub. No.: US 2025/0202649 A1
(43) Pub. Date: Jun. 19, 2025

(54) MOBILITY BASED SOUNDING REFERENCE SIGNAL PERIODICITY SELECTION

(71) Applicant: T-Mobile Innovations LLC, Overland Park, KS (US)

(72) Inventors: Timur KOCHIEV, Irvine, CA (US); Mochamad MIRZA, Bothell, WA (US)

(21) Appl. No.: 18/543,316

(22) Filed: Dec. 18, 2023

(51) Int. Cl. H04L 5/00; H04L 5/14

(52) U.S. Cl. CPC H04L 5/0051; H04L 5/14

(57) ABSTRACT

Methods provided herein include grouping wireless devices connected to an access node in a network into one of a mobile group and a stationary group when at least some of the wireless devices in the network utilize time division duplexing (TDD) and frequency division duplexing (FDD) carrier aggregation (CA) and further utilize sounding reference signal (SRS) antenna switching to send SRS to the access node from receiving antennas of the wireless devices. The method further includes adjusting a periodicity for receiving the SRS from the wireless devices belonging to the stationary group, causing the wireless devices in the stationary group to send the SRS to the access node less frequently than the wireless devices in the mobile group.

### TECHNICAL BACKGROUND

As wireless networks evolve and grow, there are ongoing challenges in communicating data across different types of networks. For example, a wireless network may include one or more access nodes, such as base stations, including, for example evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, as well as 4G long-term evolution (LTE) access nodes.

With these increasing numbers and types of access nodes deployed within wireless networks, network operators are using carrier aggregation, which enables wireless devices and access nodes to communicate using a combination of component carriers. Component carriers utilize air-interface resources (such as time-frequency resource blocks) spanning different sets of frequencies within one or more frequency bands available to use within a wireless sector. For example, intra-band carrier aggregation involves two or more component carriers using the same or contiguous frequency bands, and inter-band carrier aggregation involves component carriers using different frequency bands that may be separated by a gap.

Wireless devices that are capable of inter-band carrier aggregation can receive and send data streams using component carriers in different frequency bands. Further, access nodes can be configured to deploy a frequency-division-duplexing (FDD) carrier and a time-division-duplexing (TDD) carrier, and schedule data transmissions via both carriers using either intra-band or inter-band carrier aggregation. Thus, wireless devices that are capable of carrier aggregation and TDD and FDD communication can send and receive data streams using any combination of different TDD and FDD carriers. Further, with the evolution of 5G, mm-wave, and sub-6G, increasing numbers of antennae can be used to form beams or perform multiple-in multiple-out (MIMO) operating modes, including single-user (SU-MIMO) and/or a multi-user (MU-MIMO) mode.

Sounding reference signals (SRS) are transmitted by antennas of wireless devices or user equipment (UE) on the uplink to an access node and allow the network to estimate the quality of the channel at different frequencies. Upon receiving the SRS from the UE, the access node measures and analyzes the received signal. Once the access node has estimated the channel state based on the SRS, it uses this information to optimize its resource allocation and scheduling decisions. These decisions can involve adjusting transmission parameters (such as modulation and coding schemes) or selecting the most appropriate MIMO settings to enhance the overall system capacity and improve the user experience. SRS transmission may include antenna switching, also known as reciprocity-based downlink MIMO, which allows transmission of the SRS from receive antennas of the wireless device. Because the number of receive antennas of a wireless device is typically larger than the number of transmit antennas, SRS antenna switching provides for more efficient channel quality estimation by the access node. Massive MIMO Beamforming based on SRS antenna switching with TDD used as a primary cell (Pcell) impacts downlink throughput on FDD used as a secondary cell (Scell) in Evolved Universal Terrestrial Radio Access Network (E-UTRAN) New Radio-Dual Connectivity (EN-DC) and new radio (NR) CA combinations. Specifically, the network experiences degradation of downlink throughput and increased block error rate (BLER), and lower FDD downlink modulation coding scheme (MCS).

### Overview

Exemplary embodiments provided herein include a method for increasing downlink throughput in an environment where SRS antenna switching is used in combination with carrier aggregation (CA). The method includes grouping wireless devices connected to an access node in a network into one of a mobile group and a stationary group, where at least some of the wireless devices in the network utilize SRS antenna switching to send SRS to the access node from receiving antennas. The method additionally includes adjusting a periodicity for transmitting the SRS from the wireless devices belonging to the stationary group, causing the wireless devices in the stationary group to send the SRS to the access node less frequently than the wireless devices in the mobile group.

In some embodiments, wireless devices in the secondary group include fixed wireless access (FWA) devices. FWA devices can be differentiated from mobile devices based on network slice information, a service profile identifier, or other information. Further, wireless devices in the network may utilize TDD and FDD CA, such that the change in periodicity improves throughput on FDD.

In a further embodiment, a system is provided including a memory storing data and instructions and a processor coupled to the memory executing the stored instructions to perform multiple operations. The operations include grouping wireless devices connected to an access node in a network into one of a mobile group and a stationary group, wherein at least some of the wireless devices in the network utilize time division duplexing (TDD) and frequency division duplexing (FDD) carrier aggregation (CA). The operations additionally include adjusting a periodicity for receiving a sounding reference signal (SRS) from the wireless devices belonging to the stationary group, causing the wireless devices in the stationary group to send the SRS to the access node less frequently than the wireless devices in the mobile group to improve throughput on the FDD carrier.

In yet an additional embodiment, a non-transitory computer-readable medium stores instructions executed by a processor to perform multiple operations. The operations include grouping wireless devices connected to an access node in a network into one of a mobile group and a stationary group, wherein at least some of the wireless devices in the network utilizing time division duplexing (TDD) and frequency division duplexing (FDD) carrier aggregation (CA) and further utilize sounding reference signal (SRS) antenna switching to send SRS to the access node from receiving antennas of the wireless devices. The operations additionally include adjusting a periodicity for receiving the SRS from the wireless devices belonging to the stationary group, causing the wireless devices in the stationary group to send the SRS to the access node less frequently than the wireless devices in the mobile group.

### BRIEF DESCRIPTION OF THE DRAWINGS

FIG. 1 depicts an exemplary environment for SRS periodicity selection in accordance with an embodiment.

FIG. 2 depicts an exemplary SRS periodicity selection system in accordance with an embodiment.

FIG. 3 depicts an exemplary access node in accordance with an embodiment.

FIG. 4 depicts an exemplary grouping scenario in accordance with an embodiment.

FIG. 5 depicts an exemplary method in accordance with an embodiment.

FIG. 6 depicts an additional exemplary method in accordance with an embodiment.

FIG. 7 depicts an additional exemplary embodiment for implementing SRS periodicity selection.

FIG. 8 depicts an additional method for SRS periodicity selection in accordance with embodiments disclosed herein.

### DETAILED DESCRIPTION

In embodiments disclosed herein, a sounding reference signal (SRS) periodicity is selected for a group of wireless devices in order to optimize downlink throughput in an environment in which wireless devices utilize TDD/FDD carrier aggregation and SRS antenna switching. More specifically, a network environment may involve a TDD and an FDD duplexing spectrum usage technique. With FDD/TDD carrier aggregation, FDD uses separate frequencies for the uplink and the downlink and TDD executes uplink and downlink transmissions at different times, and may use a single frequency for both uplink and downlink.

While not all wireless devices are capable of CA, many have this capability. Devices capable of CA may have multiple receive (Rx) antenna ports. Each Rx antenna port may correspond to a different communication channel. Thus, the channel conditions for one Rx antenna port may be different than the channel conditions for another Rx antenna port. With SRS antenna switching, a wireless device may be configured to transmit an SRS on each of its Rx antenna ports to measure the channel conditions associated therewith. A variety of antenna port configurations exist and most wireless devices have one or two transmit (Tx) antennas and two to four Rx antennas.

CA-capable wireless devices may share antennas across several bands.

For example, antennas may be shared across 5G bands including n41, n25 and n66 bands. In this configuration, the wireless device may utilize SRS antenna switching to send the SRS to a gNB, allowing for beam determination at the gNB for downlink MIMO. The SRS antenna switching feature, when configured, transmits SRS reference signals out of the Rx antennas of the wireless device so that the gNB can more effectively determine the best beams for the wireless device for downlink MIMO.

For downlink TDD transmissions, the use of SRS antenna switching by the wireless devices does not create any degradation issues because slots are preassigned for uplink transmission. However, the antenna switching feature can be used, for example with new radio carrier aggregation (NRCA), where TDD is used for a primary cell (Pcell) and FDD is used for one or more of the secondary cells (Scells). If the Scell is using FDD, and the Pcell is TDD, using SRS antenna switching can create a problem with respect to the FDD downlink transmission for the Scell. In the Scell, the gNB sends FDD downlink signals continuously. Thus, when a shared Rx antenna is used to send the SRS in the uplink, the FDD reception of the Rx antenna is punctured. The puncturing of the FDD reception leads to an increased FDD block error rate (BLER), lower FDD downlink modulation coding scheme (MCS), and FDD downlink throughput degradation.

As a specific example, currently, with some existing hardware designs, n25 and n41 bands share the same receive antennas on wireless devices. During SRS antenna switching, the Rx antennas transmit reference signals and the transmit attaches to those Rx antennas just for a brief period to transmit the SRS and then releases it. This enables the gNB to better estimate and select the best beams which the wireless devices can use to achieve the optimal MIMO configuration. Band n41 is in the time domain and therefore has a time slot for transmitting the SRS over these Rx antennas. However, when band 41 is aggregated with band 25, which is an FDD band, the SRS transmissions puncture the n25 FTD reception while transmitting these SRS back to the gNB. Thus, the n25 SCell is forced to retransmit due to the momentary interruption. The necessity for retransmitting increases the FDD BLER, decreases FDD throughput, and lowers FDD downlink MCS.

In order to mitigate the difficulties described above, embodiments disclosed herein extend SRS periodicity from a default value for certain groups of wireless devices such as stationary wireless devices. For example, embodiments proposed herein, extend SRS periodicity from a default value of 20 ms to an adjusted value of 40 ms for stationary wireless devices. In order to implement this adjustment, embodiments disclosed herein utilize a wireless device grouping framework to group wireless devices, for example into a stationary group and a mobile group. In this scenario, network slice assistance information (NSSAI) and service profile identifier (SPID) might be used to differentiate between the stationary and mobile devices. Further, the mobile device may be enhanced mobile broadband (eMBB) devices and the stationary devices may be FWA devices. The adjustment is applied to stationary devices because SRS feedback from stationary devices is more constant and does not change as often as SRS feedback from mobile devices. Accordingly, instructing stationary devices to send SRS feedback less frequently helps reduce interference, for example, during downlink communications on the FDD SCell. While embodiments described herein generally refer to stationary wireless devices, other categories of wireless devices may benefit from the SRS periodicity adjustment. For example, wireless devices having different latency requirements and lower service requirements could also benefit from less frequent SRS transmissions.

By adjusting the SRS periodicity for the above-identified wireless users, other wireless device users are not negatively impacted. For example, if SRS periodicity is increased for stationary users, mobile users are not negatively impacted. However, the stationary wireless device users benefit from improved SCell downlink throughput on FDD. Further, given the decreased interference resulting from the adjustment, it is possible to increase a number of SRS wireless device users upon making the periodicity adjustment for the stationary wireless devices.

Accordingly, embodiments set forth herein adjust SRS periodicity for use by stationary devices using SRS antenna switching in a TDD/FDD NRCA environment to minimize FDD BLER and FDD throughput degradation. Thus, in embodiments set forth herein, exemplary wireless devices are simultaneously connecting to a PCell of the RAN using TDD and connecting to an Scell of the RAN using FDD. For these wireless devices, systems and methods provided herein adjust the SRS periodicity to decrease interference. The receive antennas may be shared over multiple frequency bands. The multiple frequency bands may include, for example n41, n25, and n66 bands, which may be utilized during new radio carrier aggregation (NRCA). This method minimizes interference with FDD downlink signals that occurs due to SRS antenna switching. Thus, FDD BLER and FDD throughput degradation are also minimized.

Under certain undesirable conditions, the wireless devices may have a need for increased frequency of reporting to the network entity in order to benefit from resource reallocation. However, under conditions that are predictable and stable, such as for FWA devices experiencing little channel condition variation, repeated re-evaluation is unnecessary and increases overhead. Accordingly, a system is needed that will dynamically alter the stored SRS periodicity for transmissions between base stations and selected connected wireless devices. Further, there is a need for systems and methods that can improve overall resource utilization and improve performance within a wireless network.

An exemplary system described herein includes at least an access node (or base station), such as an eNodeB, a next generation NodeB (gNodeB), and a plurality of end-user wireless devices. For illustrative purposes and simplicity, the disclosed technology will be illustrated and discussed as being implemented in the communications between an access node (e.g., a base station) and a wireless device (e.g., an end-user wireless device

In addition to the systems and methods described herein, the operations for dynamically adjusting reporting periodicity may be implemented as computer-readable instructions or methods, and processing nodes on the network for executing the instructions or methods. The processing node may include a processor included in the access node or a processor included in any controller node in the wireless network that is coupled to the access node.

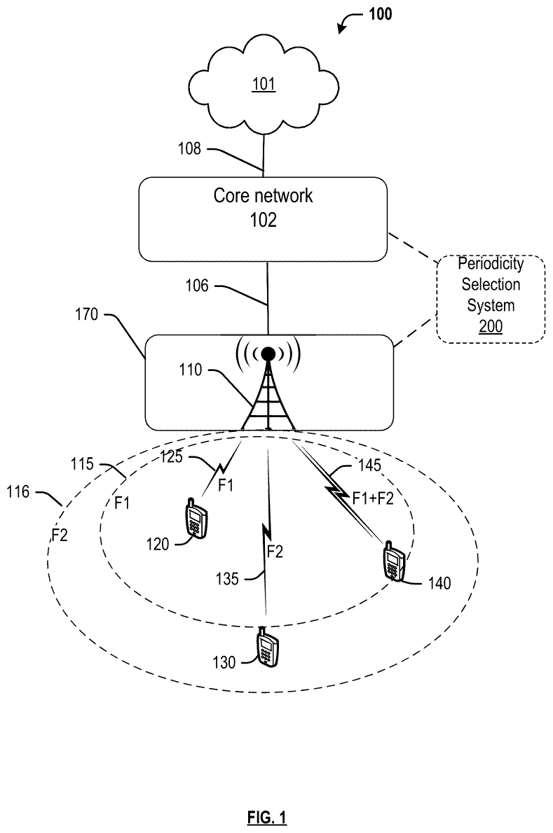

FIG. 1 depicts an exemplary environment 100 for implementing SRS periodicity adjustment in a wireless network. In the displayed environment, when CA is enabled, wireless devices that are capable of CA can use two carriers, in particular using one carrier as a primary component carrier while one or more additional carriers can be used as secondary carriers. In some embodiments, the primary carrier may be for uplink transmissions and the secondary carrier may be used for downlink transmissions. However, in other embodiments, one or both carriers may be utilized for both downlink and downlink transmission.

Environment 100 comprises a communication network 101, core network 102, and a radio access network (RAN) 170 including at least an access node 110. Wireless devices 120, 130, and 140 communicate with the access node 110. Further, a periodicity selection system 200 operates to select periodicity for groupings of the wireless devices 120, 130, 140. Furthermore, components not shown may include, for example, gateway node(s) controller nodes, and additional access nodes.

Access node 110 can be any network node configured to provide communication between end-user wireless devices 120, 130, 140 and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like. Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 120, 130, 140 are illustrated in FIG. 1, any number of access nodes and wireless devices can be implemented within environment 100.

As further described herein, by utilizing antennas, access node 110 can deploy a wireless air interface using two or more frequency bands, including but not limited to a first frequency band F1 over a coverage area 115, and a second frequency band F2 over a coverage area 116. In an exemplary embodiment, frequency band F1 uses frequencies that are higher than frequency band F2. Thus, due to propagation characteristics, coverage area 115 is smaller than coverage area 116. Further, the different sets of antennas can be used to implement various transmission modes or operating modes in each sector, including but not limited to MIMO (including SU-MIMO, MU-MIMO, mMIMO, beamforming, etc.), carrier aggregation (including inter-band and intra-band carrier aggregation), and different duplexing modes including FDD and TDD.

For example, as illustrated herein, some of the antennas of access node 110 can be allocated towards deploying a first carrier using frequency F1, to which wireless device 120 attaches using wireless connection 125. Other antennas of access node 110 can be allocated towards deploying a second carrier using frequency F2, to which wireless device 130 attaches using wireless connection 135. Additionally, multiple access nodes may be provided, each deploying multiple antennas. Further, wireless device 140, at an edge of coverage area 115, can be configured to send and receive data via wireless connection 145, which includes resources from both carriers F1 and F2. Further, the first carrier using frequency F1 can be configured to utilize either FDD or TDD modes of operation, and the second carrier using frequency F2 can be configured to utilize a different mode of operation than the first carrier.

Thus, in an exemplary embodiment, wireless device 140 is capable of carrier aggregation using the second carrier F2 as a primary component carrier and the first carrier F1 as a secondary component carrier. Thus, access node 110 can be said to deploy a PCell corresponding to F2 and an SCell corresponding to F1. In an embodiment specifically described herein, TDD mode is used for F2 and FDD mode is used for F1. F2 may for example utilize n41 band and F1 may utilize n25. Other combinations of CA and duplexing modes may be utilized. For example, wireless device 120 may not be capable of inter-band carrier aggregation, yet may be able to perform intra-band carrier aggregation, utilizing two carriers deployed in frequency F1 or an immediately contiguous frequency band.

The exemplary operating environment 100 may further include periodicity selection system 200, which is illustrated as operating between the core network 102 and the RAN 170. However, it should be noted that the periodicity selection system 200 may operate in the core 102, in the RAN 170, or may be distributed. For example, the periodicity selection system 200 may utilize components located at both the core network 102 and at the multiple access nodes 110. Alternatively, the periodicity selection system 200 may be an entirely discrete system operating in conjunction with the RAN 170, core 102 and/or the wireless devices 120, 130, 140.

The periodicity selection system 200 receives information pertaining to wireless devices from wireless devices 120, 130, 140. For example, the periodicity selection system 200 may collect performance parameters, location information, capabilities, and identification information. In embodiments set forth herein, the wireless devices 120, 130, 140 may send these parameters to the access nodes 110, which convey relevant parameters to the periodicity selection system 200. The periodicity selection system 200 analyzes this information in order to determine a grouping and ultimately a periodicity for a wireless device. For example, the periodicity selection system 200 may be configured to execute methods including grouping wireless devices and assigning an SRS periodicity to the groups. The groups may include, for example, at least one stationary group and at least one mobile group. The periodicity selection system 200 may perform the groupings based on information including, for example, single-network slice assistance information (S-NSSAI), a slice service type (SST), a slice differentiator (SD), or a service profile identifier (SPID). Further, the access node 110 may receive SRS from the wireless devices and may determine an appropriate beam configuration for downlink MIMO based on the received SRS. Thus, exemplary embodiments described herein include instructing wireless devices to use a particular SRS periodicity based on a grouping. For example, wireless devices grouped into a stationary group may be configured to send SRS less frequently than wireless devices utilized in a mobile group.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Once the access node 110 has estimated the channel state based on the SRS, it uses this information to optimize its resource allocation and scheduling decisions. These decisions can involve adjusting transmission parameters (such as modulation and coding schemes) or selecting the most appropriate MIMO settings to enhance the overall system capacity and improve the user experience. Often, the SRS is used for an access node to determine appropriate MIMO/precoding for downlink in time division duplexing (TDD). Since the channel property for downlink and uplink is same (channel reciprocity) in TDD, the channel estimation result for uplink based on SRS can be utilized for optimizing downlink process. By leveraging the SRS, the access node can adapt to the dynamic nature of the radio environment and provide more efficient and reliable communication services.

Further, the access node 110 may communicate with the periodicity selection system 200 or alternatively may wholly or partially incorporate the periodicity selection system 200. Thus, the periodicity selection system 200 may select a periodicity for a grouping of wireless devices and may communicate this periodicity to the access node 110 so that the access node 110 can provide an appropriate instruction to each wireless device, for example through a radio resource control (RRC) message.

Wireless devices 120, 130, 140 may be any device, system, combination of devices, or other such communication platform capable of communicating wirelessly with access node 110 using one or more frequency bands deployed therefrom. Wireless devices 120, 130, 140 may be, for example, a mobile phone, a wireless phone, a wireless modem, a personal digital assistant (PDA), a voice over internet protocol (VOIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. Other types of communication platforms are possible.

While wireless phones may generally be mobile, HINT and FWA devices may generally be stationary. Moreover, wireless device 140 can also be equipped with antennas enabling the different types of transmissions as set forth above. For example, wireless device 120, 130, 140 can simultaneously communicate with access node 110 using a first antenna or set of antennas for transmission 115 and a second combination of antennas for transmission 116.

Subsequent to sending capabilities to the access node 110, for example, through a UE capability information message, the wireless devices 120, 130, 140 may receive instructions from the access node 110. The instructions may, for example, instruct the wireless devices 120, 130, 140, to utilize a particular SRS periodicity based on a group assigned to the wireless device 120, 130, 140 by the access node 110. The instruction may be an information element sent via RRC message, in a system information block (SIB) message, or any equivalent means. The instruction can be sent responsive to receiving the service request, or periodically throughout a communication session. The instruction may specify that the wireless device 120, 130, 140 should utilize a default periodicity, e.g., 20 ms, when the wireless device is assigned to a mobile group, or that the wireless device 120, 130, 140 should adjust its periodicity, e.g., to 40 ms., if the wireless device 120, 130, 140 belongs to the stationary group.

The core network 102 includes core network functions and elements. The core network may have an evolved packet core (EPC) structure or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120, 130, 140 and is responsible for handling connection and mobility management tasks. The SMF is primarily responsible for creating updating and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120, 130, 140, etc. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

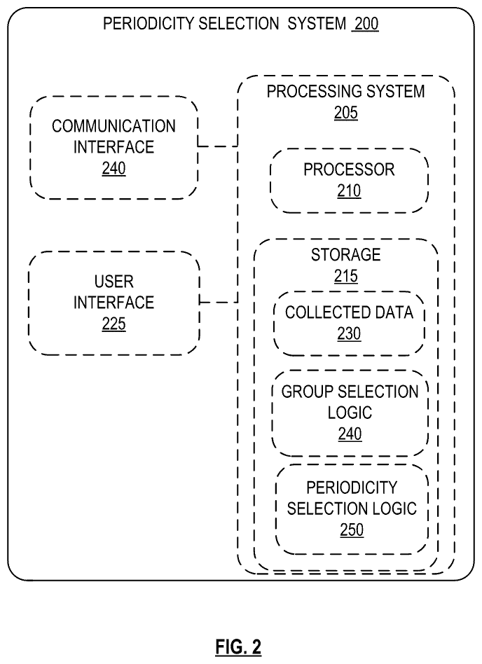

FIG. 2 illustrates a periodicity selection system 200 in accordance with embodiments described herein. The components described herein are merely exemplary as many different configurations for the periodicity selection system 200 may be implemented. The periodicity selection system 200 may be configured to perform the methods and operations disclosed herein to dynamically set periodicity for different groups of wireless devices. In the disclosed embodiments, the periodicity selection system 200 may be integrated with each access node 110, integrated with the core network 102 or may be an entirely separate component capable of communicating with at least the wireless devices 120, 130, 140 and the RAN 170. Further, the components of the periodicity selection system 200 may be distributed so that one or more components is located at an access node 110 and one or more other components are located within a separate processing node or at the core network 102.

The periodicity selection system 200 may be configured for collecting data transmitted by the wireless devices 120, 130, 140 to the access nodes 110. To perform periodicity selection, the periodicity selection system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein. For example, group selection logic 240 may store instructions to form groups of wireless devices based on collected data 230 and periodicity selection logic 250 may be utilized to select a periodicity for each group. Further, the memory 215 may store the collected data at 230, which may be or include data collected from the wireless devices 120, 130, 140, from the RAN 170 or from the core network 102. To perform the above-described operations, the group selection logic 240 and periodicity selection logic 250 may be executed by the processor 210 to operate on the collected data 230.

Processor 210 may be a microprocessor and may include hardware circuitry and/or embedded codes configured to retrieve and execute software stored in storage device 215. The periodicity selection system 200 further includes a communication interface 220 and a user interface 225. Communication interface 220 may be configured to enable the processing system 205 to communicate with other components, nodes, or devices in the wireless network. For example, the periodicity selection system 200 receives relevant parameters from an access node 110 or from the wireless devices 120, 130, 140 or from the core network 102.

Communication interface 220 may include hardware components, such as network communication ports, devices, routers, wires, antenna, transceivers, etc. User interface 225 may be configured to allow a user to provide input to the periodicity selection system 200 and receive data or information from access nodes 110 or the wireless devices 120, 130, 140. User interface 225 may include hardware components, such as touch screens, buttons, displays, speakers, etc. The periodicity selection system 200 may further include other components such as a power management unit, a control interface unit, etc.

The location of the periodicity selection system 200 may depend upon the network architecture. As set forth above, the periodicity selection system 200 may be located in an access node 110, in a separate processing node, in the RAN 170, in multiple locations, or may be an entirely discrete component. Further, although shown as a single integrated system, the functions of data collection, group selection, and periodicity selection may be separated and disposed in separate locations.

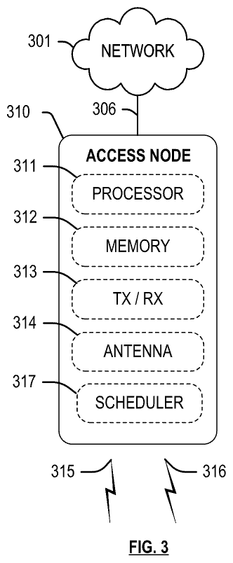

FIG. 3 depicts an exemplary access node 310. Access node 310 is configured as an access point for providing network services from network 301 to end-user wireless devices such as wireless devices 120, 130, 140 in FIG. 1. Access node 310 is illustrated as comprising a memory 312 for storing logical modules that perform operations described herein, a processor 311 for executing the logical modules, and a transceiver 313 for transmitting and receiving signals via antennas 314. Combinations of antennas 314 and transceivers 313 are configured to deploy a wireless air interface using at least two carriers, each of which uses a different frequency band. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 310 is communicatively coupled to network 301 via communication interface 306, which may be any wired or wireless link as described above. Scheduler 317 may be provided for scheduling resources based on the presence and performance parameters of the UEs 120, 130, 140. Wireless communication links 315 and 316 may deploy different duplexing modes including TDD and FDD.

In an exemplary embodiment, memory 312 includes logic for grouping wireless devices and sending SRS periodicity instructions based on the groupings. For example, access node 310 may be configured to group connected wireless devices into FWA groups and mobile groups. The access node 310 may be further configured to adjust reporting periodicity for the wireless devices based on group membership and may wholly or partially incorporate the periodicity selection system 200 described above. These features may be enabled by access node 310 comprising two co-located cells, or antenna/transceiver combinations that are mounted on the same structure. Network 301 may be similar to network 101 discussed above.

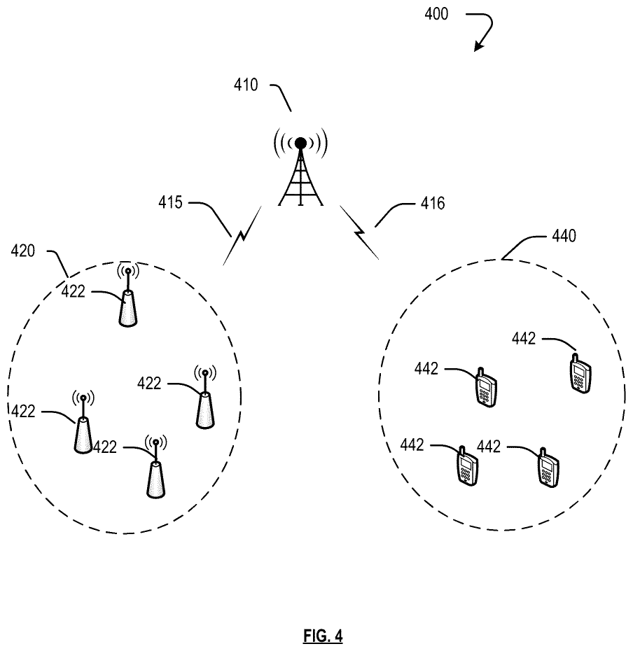

FIG. 4 depicts an environment 400 for grouping and periodicity selection in accordance with embodiments disclosed herein. Access node 410 communicates with wireless devices 422, 442 over communication links 415 and 416 in accordance with disclosed embodiments. The wireless devices may be placed in wireless device groups 420 and 440. The group 420 may include stationary wireless devices 422, which may be FWA devices. The group 440 may include mobile wireless devices 442, which may be eMBB devices. Thus, the group 440 may be a mobile group and the group 420 may be a stationary group.

Wireless devices 422 and 442 in both stationary and mobile groups transmit a sounding reference signal (SRS) to the base station 410 in the uplink direction. The SRS is transmitted for uplink channel sounding, including channel quality estimation and synchronization. The transmission of the SRS can serve to be a contributing factor limiting the number of wireless devices that can be served by a base station.

Thus, the access node 410 groups the wireless devices 422, 442 into the stationary group 420 and the mobile group 440. The access node 410 may accomplish the grouping using a variety of techniques. For example, the access node 410 may group the wireless devices based on respective single-network slice selection assistance information (S-NSSAI). S-NSSAI is an identifier for a network slice across the 5G core, 5G-RAN and the UE. The S-NSSAI may include a slice service type (SST) and a slice differentiator (SD). SST refers to the expected network slice behavior in terms of features and services. SD complements the SST to differentiate amongst multiple network slices of the same SST.

The access node 410 may, for example, group the wireless devices having a first SD value in the stationary group 420 and group wireless devices with a second SD value in the mobile group 440. For example, the SST for both groups may be equal to one. However, the SD for the mobile group may be equal to zero and the SD for the stationary group may be equal to one.

In further embodiments, the access node 410 may group the wireless devices based on a public land mobile network identifier (PLMN-ID). Alternatively, the access node 410 may group the wireless devices based on a quality of service (QOS) class identifier (QCI). As a further alternative, the access node 410 may group the wireless devices based on a, 5G QoS identifier (5QI). Yet a further alternative includes grouping the wireless devices based on a service profile identifier/RAT frequency selection priority index (SPID/RFSP). Additional alternatives include grouping the wireless devices based on international mobile equipment identity-type allocation code (IMEI-TAC), international mobile station equipment identity software (IMEI-SV) and/or international mobile station equipment identity software version (IMEISV). Various combinations of the aforementioned indicators may be utilized by the access node 410 to group the wireless devices.

In embodiments set forth herein, once the access node 410 groups the wireless devices 422, 442, the access node 410 may adjust the SRS periodicity for wireless devices 422 in the stationary group 420. In some embodiments, the SRS periodicity may be adjusted to a maximum allowed by the network. While accurate channel condition reporting is important for mobile users as channel conditions can change rapidly due to high mobility, the situation is completely different for the stationary devices 422. Because these wireless devices are stationary, their channel conditions are relatively stable. In some embodiments, the maximum SRS periodicity allowed by the network may, for example, be 80 ms. The access node 410 may alternatively increase the SRS periodicity for the wireless devices 422 to another value which is greater than an initial default value, but less than the maximum allowed by the network. In contrast, the access node 410 may not adjust the SRS periodicity for the wireless devices 442 in the mobile group 440.

In embodiments set forth herein, the access node 410 is further able to increase a number of connected wireless devices in the stationary group 420 based on the adjusted SRS periodicity. The number of UEs accommodated by the SRS is limited by both antenna switching type and SRS periodicity. Because the allowed number of SRS users depends on both antenna switching type (xTyR) and SRS periodicity, adjusting either one of these quantities can lead to an increase in the allowed number of SRS users. For example, in a network utilizing a 2T4R antenna switching, increasing SRS periodicity from 40 ms to 80 ms doubles the number of allowed SRS users for multi-user MIMO.

Further, while the access node 410 changes the SRS periodicity for the stationary group 420, the access node 410 leaves the SRS periodicity for the mobile group 440 unchanged as the channel conditions for the mobile group 440 may be much less stable than for the stationary group 420. The aforementioned periodicity adjustments will positively impact performance for the stationary group by reducing overhead and allowing the number of users to increase. The adjustment to periodicity for the stationary group is configured to improve overall network performance. Thus, in this disclosure, optimization of SRS periodicity for stationary wireless devices improves downlink throughput and increases the number of SRS users that can be accommodated.

Further, as the access node 410 is described as performing the methods described herein, processing nodes, gateway nodes, or other nodes in the RAN 170 may employ methods disclosed to identify stationary devices and form a stationary group and a mobile group. The node may then adjust the reporting periodicity for the stationary devices as further described herein. Additionally, the node may adjust the reporting periodicity for devices in the mobile group on an individual basis based on RF conditions.

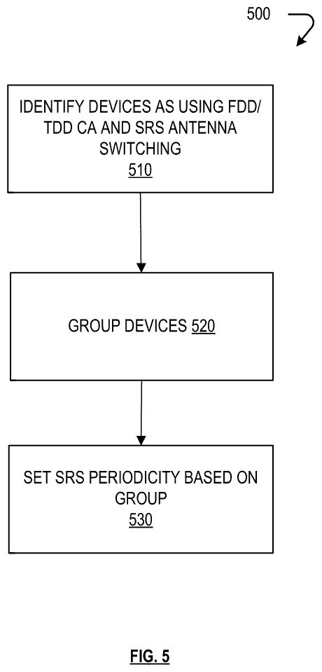

FIG. 5 illustrates an exemplary method 500 for dynamically adjusting SRS reporting protocols for wireless devices in a network. Method 500 may be performed by any suitable processor discussed herein, for example, a processor included in access node 110 or 410, or a processor included in the periodicity selection system 200. For discussion purposes, as an example, method 500 is described as being performed by a processor included in access node 410.

Method 500 starts in step 510, in which the access node 410 may identify that devices in the network utilize FDD/TDD CA and SRS antenna switching. As set forth above, the SRS antenna switching can cause interference on the FDD downlink.

In step 520, the access node 410 may group wireless devices in the network. As set forth above, the wireless devices may be grouped based on mobility. However, other alternatives include grouping based on latency and QoS requirements. Thus, the access node 410 creates two groups of wireless devices. In further embodiments, the access node 410 may group the wireless devices based on a public land mobile network identifier (PLMN-ID). Alternatively, the access node 410 may group the wireless devices based on a quality of service (QOS) class identifier (QCI). As a further alternative, the access node 410 may group the wireless devices based on a, 5G QoS identifier (5QI). Yet a further alternative includes grouping the wireless devices based on a service profile identifier/RAT frequency selection priority index (SPID/RFSP). Additional alternatives include grouping the wireless devices based on international mobile equipment identity-type allocation code (IMEI-TAC), international mobile station equipment identity software (IMEI-SV) and/or international mobile station equipment identity software version (IMEISV). Various combinations of the aforementioned indicators may be utilized by the access node 410 to group the wireless devices.

Finally, in step 530, the access node 410 adjusts SRS periodicity for at least one of the two groups. In some embodiments, SRS periodicity may be adjusted for both of the groups. For example, a group of stationary wireless devices or a group of wireless devices having a low QoS requirement may be subject to an increase in SRS periodicity, so that these groups of devices send SRS to the access node less frequently. Groups of devices with high mobility and/or high QoS may be subject to decreased SRS periodicity, such that the SRS is sent more often to ensure a high quality of service. Alternatively, the SRS periodicity for one group may be adjusted and the SRS periodicity for the other group may remain the same.

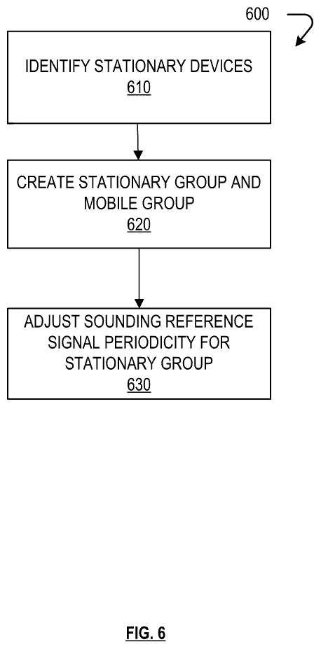

FIG. 6 depicts an exemplary method 600 for grouping wireless devices and adjusting SRS periodicity in accordance with embodiments described herein. Method 600 may be performed by any suitable processor discussed herein, for example, a processor included in access node 110 or 410, or a processor in the periodicity selection system 200. For discussion purposes, as an example, method 600 is described as being performed by a processor included in access node 410.

In step 610, the access node 410 may identify stationary devices, such as FWA devices. In embodiments described herein, the access node 410 uses network slice information as described above to identify the FWA devices. However, other methods of identifying FWA devices are within scope of the disclosure.

In step 620, the access node 410 creates two groups of wireless devices, including a stationary group and a mobile group and puts the connected wireless devices in one of the two groups. The stationary group will have relatively stable channel conditions. The mobile group may experience varying channel conditions as the wireless devices within the mobile group move between different locations with different signal conditions.

Finally, in step 630, the access node 410 adjusts the periodicity for SRS for the stationary group. For example, the access node 410 may adjust the periodicity for the SRS to be the maximum established by the network. The established maximum value may be predetermined and may be stored, for example, in a network database or a memory of the access node 410 or the periodicity selection system 200. Because the SRS is transmitted in the uplink by the wireless device to the access node 410, the access node 410 may instruct the wireless device to decrease its SRS frequency (i.e., increase the SRS periodicity) through an RRC reconfiguration message or another message directed specifically to the wireless device. The increase in periodicity or decrease in frequency of signal transmission leads to less frequent reallocation of resources where channel conditions are stable, thereby reducing overhead. As set forth above, the reduction in reporting frequency reduces overhead for the stationary group. The stationary wireless devices typically do not experience changes in channel conditions that require reallocation of resources. In further embodiments, the access node 410 may transform a periodic reporting scheme to an aperiodic reporting scheme or vice versa as long as the SRS from the stationary wireless devices are transmitted less frequently than the stored protocol.

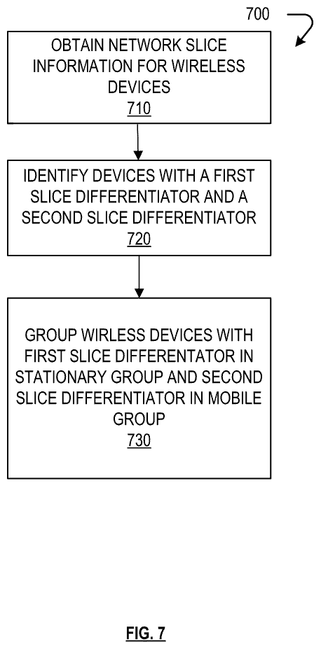

FIG. 7 illustrates a method 700 for grouping wireless devices in accordance with embodiments described herein. Method 700 may be performed by any suitable processor discussed herein, for example, a processor included in access node 110 or 410 or a processor included in the periodicity selection system 200. For discussion purposes, as an example, method 700 is described as being performed by a processor included in access node 410.

In step 710, the access node 410 obtains network slice information for the wireless devices. Each wireless device may access multiple slices over the same access node. S-NSSAI is an identifier for a network slice. S-NSSAI may include a slice service type (SST) and slice differentiator (SD).

In step 720, the access node 410 identifies devices with a first SD and a second SD. The SD differentiates between multiple network slices with the same SST. The access node 410 may, for example, identify first and second SDs for the connected wireless devices.

In step 730, the access node 410 may group the wireless devices having a first SD value in the stationary or FWA group and group wireless devices with a second SD value in the mobile group. For example, the SST for both groups may be equal to one. However, the SD for the mobile group may be equal to zero and the SD for the FWA group may be equal to one.

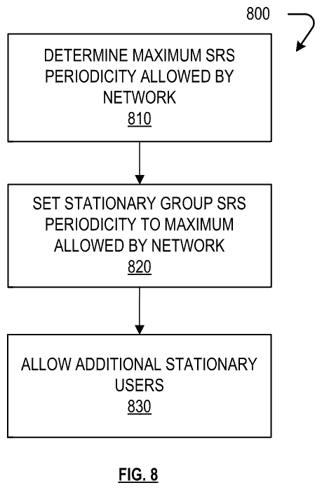

FIG. 8 depicts an exemplary method 800 for adjusting SRS periodicity and increasing a number of SRS users in accordance with disclosed embodiments. Method 800 may be performed by any suitable processor discussed herein, for example, a processor included in access node 110 or 410, or a processor included in the periodicity selection system 200. For discussion purposes, as an example, method 800 is described as being performed by a processor included in access node 410.

In step 810, the access node 410 determines a maximum SRS periodicity allowed by the network. The maximum SRS periodicity allowed by the network may be stored, for example, in a network database, or in a memory of the access node 410. In one embodiment, the maximum periodicity may be 80 ms. However, in another embodiment, FWA devices may be able to eliminate reporting entirely, such as when no maximum periodicity is stored.

In step 820, the access node 410 sets the stationary group SRS periodicity to a maximum periodicity identified in step 810. As set forth above, the reduction in reporting frequency reduces overhead for the stationary group. The wireless devices in the stationary group typically do not experience changes in channel conditions that require reallocation of resources. The access node 410 may send a message to the wireless devices in the stationary group directing them to report less frequently. For example, stationary devices reporting every 40 ms may be directed to report every 80 ms.

In step 830, the access node 410 may allow additional stationary devices, such as FWA devices to connect. As set forth above, the increase in the reporting periodicity may permit twice as many devices to connect. Thus, if eight devices are connected prior to the change in SRS periodicity, sixteen devices may be connected once the change in periodicity occurs.

Accordingly, as set forth above, embodiments provided herein increase reporting periodicity, thus decreasing reporting frequency. Because SRS reporting consumes resources, it is desirable to reduce reporting for stationary devices or any other devices unlikely to experience drastic changes in channel conditions. This method has no negative impact on eMBB users, results in improved SCell throughput, particularly on mid-band FDD for stationary users, and allows for an increased number of SRS users.

In some embodiments, methods 500, 600, 700, and 800 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 500, 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
grouping wireless devices connected to an access node in a network into one of a mobile group and a stationary group, at least some of the wireless devices in the network utilizing sounding reference signal (SRS) antenna switching to send SRS to the access node from receiving antennas; and
adjusting a periodicity for receiving the SRS from the wireless devices belonging to the stationary group, causing the wireless devices in the stationary group to send the SRS to the access node less frequently than the wireless devices in the mobile group.

2. The method of claim 1, wherein the stationary group comprises fixed wireless access (FWA) devices.

3. The method of claim 1, further comprising grouping the wireless devices based on respective single-network slice selection assistance information (S-NSSAI).

4. The method of claim 3, wherein the S-NSSAI includes a slice service type (SST) and a slice differentiator (SD) and grouping the wireless devices includes grouping wireless devices having a first SD value in the stationary group.

5. The method of claim 4, further comprising grouping wireless devices with a second SD value in the mobile group.

6. The method of claim 1, further comprising grouping the wireless devices based on a service profile identifier (SPID).

7. The method of claim 1, further comprising adjusting the SRS periodicity for the stationary group to a maximum allowed by the network.

8. The method of claim 1, further comprising increasing a number of connected wireless devices in the stationary group based on the adjusted SRS periodicity.

9. The method of claim 1, wherein the wireless devices in the stationary group using time division duplexing (TDD) and frequency division duplexing (FDD) carrier aggregation experience improved secondary cell (SCell) throughput on FDD triggered by the periodicity adjustment.

10. A system comprising:
a memory storing data and instructions; and
a processor coupled to the memory executing the stored instructions to perform operations comprising:
grouping wireless devices connected to an access node in a network into one of a mobile group and a stationary group, at least some of the wireless devices in the network utilizing time division duplexing (TDD) and frequency division duplexing (FDD) carrier aggregation (CA); and
adjusting a periodicity for receiving a sounding reference signal (SRS) from the wireless devices belonging to the stationary group, causing the wireless devices in the stationary group to send the SRS to the access node less frequently than the wireless devices in the mobile group to improve throughput on the FDD carrier.

11. The system of claim 10, wherein the stationary group comprises fixed wireless access (FWA) devices.

12. The system of claim 10, the operations further comprising grouping the wireless devices based on respective single-network slice selection assistance information (S-NSSAI).

13. The system of claim 12, wherein the S-NSSAI includes a slice service type (SST) and a slice differentiator (SD) and the operations further comprise grouping the wireless devices having a first SD value in the stationary group.

14. The system of claim 13, the operations further comprising grouping wireless devices with a second SD value in the mobile group.

15. The system of claim 10, the operations further comprising grouping the wireless devices based on a service profile identifier (SPID).

16. The system of claim 10, the operations further comprising increasing a number of connected wireless devices in the stationary group based on the adjusted SRS periodicity.

17. The system of claim 10, wherein at least some of the wireless devices utilize SRS antenna switching to send the SRS from receive antennas of the wireless devices.

18. A non-transitory computer-readable medium storing instructions executed by a processor to perform multiple operations comprising:
grouping wireless devices connected to an access node in a network into one of a mobile group and a stationary group, at least some of the wireless devices in the network utilizing time division duplexing (TDD) and frequency division duplexing (FDD) carrier aggregation (CA) and utilizing sounding reference signal (SRS) antenna switching to send SRS to the access node from receiving antennas of the wireless devices; and
adjusting a periodicity for receiving the SRS from the wireless devices belonging to the stationary group, causing the wireless devices in the stationary group to send the SRS to the access node less frequently than the wireless devices in the mobile group.

19. The non-transitory computer-readable medium of claim 18, wherein the stationary group comprises fixed wireless access (FWA) devices.

20. The non-transitory computer-readable medium of claim 18, the operations further comprising grouping the wireless devices based on respective single-network slice selection assistance information (S-NSSAI).
